(19) United States
(12) Patent Application Publication
(10) Pub. No.: US 2016/0266797 A1
(43) Pub. Date: Sep. 15, 2016

(54) Caching On Ephemeral Storage

(71) Applicant: CacheBox Inc., San Carlos, CA (US)

(72) Inventors: Murali Nagaraj, Pune (IN); Sumit Kumar, Pune (IN); Sumit Kapoor, Pune (IN); Lorenzo Salhi, San Carlos, CA (US); John Groff, San Carlos, CA (US)

(21) Appl. No.: 15/063,169

(22) Filed: Mar. 7, 2016

Related U.S. Application Data
(60) Provisional application No. 62/129,824, filed on Mar. 7, 2015.

(51) Int. Cl. G06F 3/06; G06F 12/08

(52) U.S. Cl. CPC G06F 3/061; G06F 3/0631; G06F 3/0632; G06F 3/0659; G06F 3/0665; G06F 3/067; G06F 12/0875; G06F 2212/1016; G06F 2212/152; G06F 2212/154; G06F 2212/163; G06F 2212/222; G06F 2212/452

(57) ABSTRACT

In an embodiment of the invention, an apparatus comprises: a physical server; a guest operating system (OS) instance that runs on the physical server; a cache communicatively coupled to the guest OS instance via the physical server and allocated the guest OS; a plurality of storage units; wherein the guest OS instance is configured to access data in the plurality of storage units via a network; and wherein the cache is configured to boost a performance of a guest OS machine of the guest OS instance. In another embodiment of the invention, a method comprises: accessing, by a guest operating system (OS) instance, data in a plurality of storage units via a network; and boosting, by a cache, a performance of a guest OS of the guest OS instance. In yet another embodiment of the invention, an article of manufacture, comprises a non-transient computer-readable medium having stored thereon instructions operable to permit an apparatus to: access, by a guest operating system (OS) instance, data in a plurality of storage units via a network; and boost, by a cache, a performance of a guest OS of the guest OS instance.

### CROSS-REFERENCE(S) TO RELATED APPLICATIONS

This application claims the benefit of and priority to U.S. Provisional Application 62/129,824, filed 7 Mar. 2015. This U.S. Provisional Application 62/129,824 is hereby fully incorporated herein by reference.

### FIELD

Embodiments of the invention relate generally to data storage systems.

### DESCRIPTION OF RELATED ART

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against this present disclosure.

The modern datacenter is virtualized and is in the cloud. Infrastructure as a service is delivered via an OS (operating system) virtualization technology such as, for example, VmWare, Hyper-V, Xen, or KVM. Guest OS machines are provisioned on the fly. Persistent storage for such virtual machines are allocated typically on a highly available external server or set of servers. This is typical of infrastructure service providers like Amazon Web services.

While the above-noted conventional systems are suited for their intended purpose(s), there is a continuing need for reliable data storage systems. Additionally, there is a continuing need to boost the guest OS application performance in the above-noted conventional systems.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

It is to be noted, however, that the appended drawings illustrate only typical embodiments of this invention and are therefore not to be considered limiting of its scope, for the invention may admit to other equally effective embodiments.

FIG. 1 is a block diagram of a datacenter architecture.

FIG. 2 is a block diagram of an apparatus (system), in accordance with an embodiment of the invention.

FIG. 3 is a flow diagram of a method, in accordance with an embodiment of the invention.

### DETAILED DESCRIPTION

In the following detailed description, for purposes of explanation, numerous specific details are set forth to provide a thorough understanding of the various embodiments of the present invention. Those of ordinary skill in the art will realize that these various embodiments of the present invention are illustrative only and are not intended to be limiting in any way. Other embodiments of the present invention will readily suggest themselves to such skilled persons having the benefit of this disclosure.

In addition, for clarity purposes, not all of the routine features of the embodiments described herein are shown or described. One of ordinary skill in the art would readily appreciate that in the development of any such actual implementation, numerous implementation-specific decisions may be required to achieve specific design objectives. These design objectives will vary from one implementation to another and from one developer to another. Moreover, it will be appreciated that such a development effort might be complex and time-consuming but would nevertheless be a routine engineering undertaking for those of ordinary skill in the art having the benefit of this disclosure. The various embodiments disclosed herein are not intended to limit the scope and spirit of the herein disclosure.

Preferred embodiments for carrying out the principles of the present invention are described herein with reference to the drawings. However, the present invention is not limited to the specifically described and illustrated embodiments. A person skilled in the art will appreciate that many other embodiments are possible without deviating from the basic concept of the invention. Therefore, the principles of the present invention extend to any work that falls within the scope of the appended claims.

As used herein, the terms “a” and “an” herein do not denote a limitation of quantity, but rather denote the presence of at least one of the referenced items.

It is to be also noted that the appended drawings illustrate only typical embodiments of this invention and are therefore not to be considered limiting of its scope, for the present invention may admit to other equally effective embodiments.

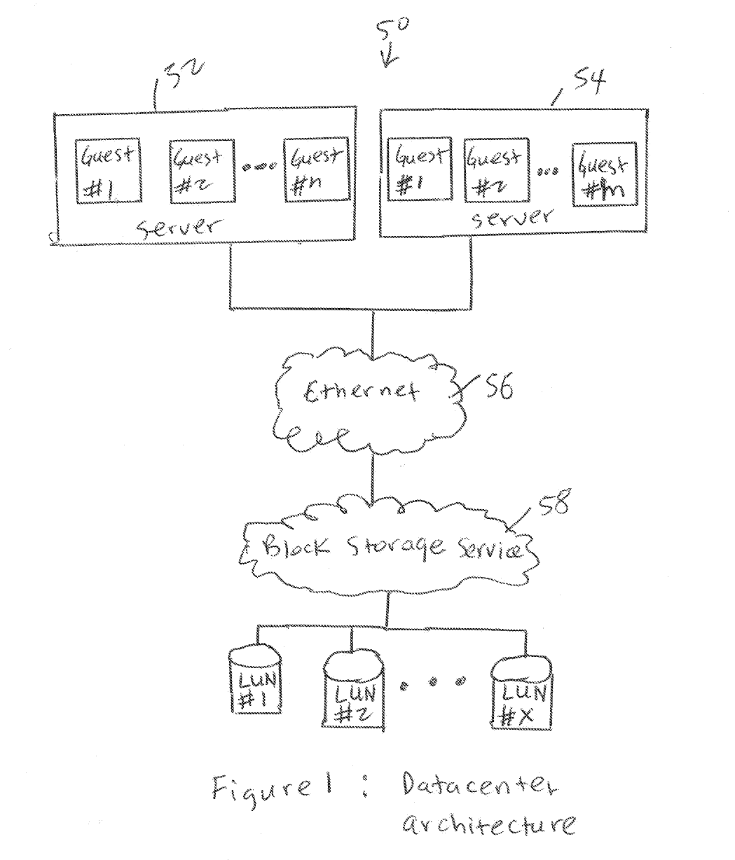

The modern datacenter is typically virtualized and is in the cloud environment. Infrastructure as a service is delivered via an OS (operating system) virtualization technology such as, for example, VmWare, Hyper-V, Xen, or KVM. Guest OS machines are typically provisioned on the fly. Persistent storage for such virtual machines are allocated typically on a highly available external server or a set of servers. This is typical of infrastructure service providers like Amazon Web Services. An example of such architecture is shown in, for example, the datacenter architecture 50 of FIG. 1. One or more Guest OS machines (e.g., Guest OS machine #1 and/or Guest OS machine #2) are allocated on a physical server 52. The server 52 can have one or more Guest OS machines, such as, for example, Guest OS machine #1, Guest OS machine #2, and Guest OS machine #n, where n can be any integer over 2. Similarly, one or more Guest OS machines can also be allocated on another physical server 54. The number of Guest OS machines can be an #m number, where m can be any integer over 2 if the physical server 54 also has similar Guest OS machine #1 and similar Guest OS machine #2.

The physical servers 52 and 54 are connected via a network 56 (e.g., Ethernet) to a block storage service 58 that manages one or more LUNs (Logical Units). Each Guest OS machine (e.g., Guest OS machine #1) accesses the storage units (e.g., LUN #1, LUN #2, or LUN #x where x can be any integer over 2).

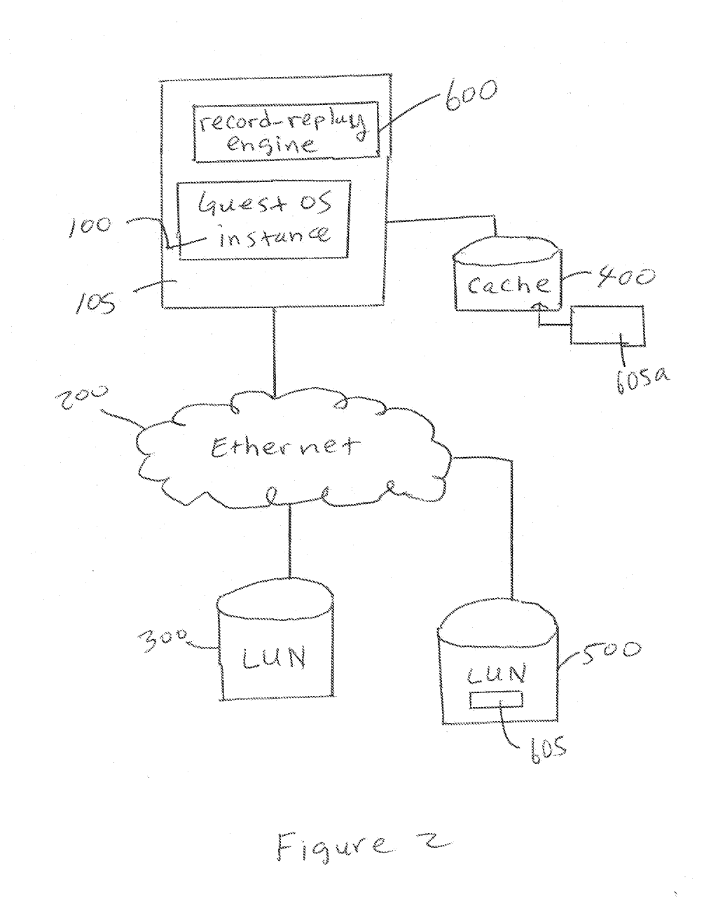

FIG. 2 is a block diagram that illustrates a Guest OS instance 100 that runs on a physical server (e.g., physical server 105) and a cache 400 communicatively coupled to the Guest OS instance 100 via the physical server 105. The Guest OS instance 100 runs on a physical server (e.g., physical server 105 or physical server 52 or physical server 54 in FIG. 1). Each physical server (e.g., server 105) is locally attached to a cache 400. The Guest OS instance 100 (and other software applications running on the Guest OS instance) will access data typically over a network 200 (e.g., the Ethernet 200) and in storage unit 300 (e.g., LUN 300) where the software application data is stored. The cache 400 is partitioned and allocated to the Guest OS instance 100.

While LUNs (300) are persistent, they have very poor random I/O (input/output) characteristics—typically between about 100 to 200 IOPS (input/output operations per second). This crucial number determines in many cases the application performance. Applications are run in the guest OS machine (100). The datacenter architecture typically has a direct attached SSD (solid state device) on each physical server. This SSD is then used to provide a thin provisioned ephemeral block storage (400) (which is typically embodied as a cache 400) to the guest (100). Because the cache 400 is embodied by a direct attached SSD in one embodiment of the invention, the cache typically has orders of magnitude of better performance than LUN (300). Typically, the IOPS are in the tens of thousands range—e.g., 50000 IOPS.

Described below are techniques to use the ephemeral storage (400) to boost guest OS application performance.

Method #1: A Method and apparatus to record application initialization I/O sequence persistently and apply the sequence upon guest OS machine restart (in order to speed up instance launch times) is provided in an embodiment of the invention.

In an embodiment of the invention, a method and apparatus for speeding up a guest OS machine instance launch time will be discussed below. This method and apparatus will record the initialization I/O (input/output) sequence of a guest OS machine application and will apply this recorded initialization sequence upon a restart of a guest OS machine in order to speed up the launch times of instances of the Guest OS machine, as will be discussed in additional details below. This method disclosed herein and apparatus disclosed herein can also be used to record the initialization I/O sequences of other types of software applications.

When a software application on the guest OS starts (or when a guest OS machine itself starts or restarts), the temporal sequence of areas (or blocks) of the LUN 300 that are accessed is recorded in a database that is hosted on persistent storage (500) which also houses the guest operating system image. Upon guest OS machine start/restart, this same sequence of blocks is fetched into the cache (400) in an optimal manner—i.e., the blocks are ordered sequentially and fetched which vastly improves the time required to fetch the data. A variation of this strategy is to record, for example, the first 30 minutes of application launch I/O trace and play the I/O trace back into the cache 400 across system restarts which vastly improves application response times for mostly static data.

In an embodiment of the invention, a record-replay engine 600 (e.g., an application specific module 600, record-and-replay module 600 or record-and-replay engine 600) will record the activities of a guest OS machine or other application for a particular session or an instance of an operation of the guest OS machine or software application. In the discussion herein, application or software application can also be defined to include a guest OS machine or another type of software application.

The architecture in FIG. 2 addresses the problem of data loss in a cache in conventional systems whenever a Guest operating system reboots for a given reason (e.g., a reboot is performed after a system maintenance is performed). When a Guest OS machine instance (i.e., also referred herein as a Guest OS instance) has to reboot, the Guest OS instance data is lost before the reboot. Therefore, in an embodiment of the invention, the record-replay engine 600 can record the application I/O (input/output) initialization sequence of a guest OS machine and can apply this initialization sequence to a guest OS instance upon a re-start of the guest OS machine in order to speed up the application launch time. In an embodiment of the invention, the record-replay engine 600 can be implemented by use of any known suitable software programming language and by use of known software programming techniques.

The LUN 500 will include partitions that are allocated to one or more guest OS instances 100. By way of example and not by way of limitation, about 10 Gigabytes of memory area in the LUN 500 is allocated for each guest OS instance. In a given memory area allocated in the LUN 500 for a given Guest OS instance 100, this given memory area will store recorded information 605 that are recorded by the record-replay engine 600 and this recorded information 605 includes data indicating which regions of the LUN 300 that was accessed by the Guest OS instance 100 during the initialization I/O sequence of the Guest OS instance 100, the size of the data in the LUN 300 that was accessed by the Guest OS instance during the initialization I/O sequence of the Guest OS instance, and the I/O sequence during the initialization of the Guest OS instance. The record-replay engine 600 will record the above information 605 into the LUN 500. When an operating system re-starts, the record-and-replay engine 600 will read the recorded information 605 in the LUN 500 and will replay the recorded information 605 into the cache 400 even before the guest OS application (or another application) will start (where the another application will run on the operating system). Therefore, the record-and-replay engine 600 will read the recorded information 605 in the LUN 500 and replay the recorded information 605 into the cache 400 when the guest operating system starts or restarts (or another software application starts or restarts, or when an instance of the guest OS or an instance of another software application starts or restarts), and this recorded information 605 is replayed before a Guest OS instance will start or restart or an application (which will run on the Guest OS) will restart. A benefit of recording and replaying the recorded information 605 directed to the initialization sequence of a Guest OS is that an instance of the Guest OS and/or an application (that will run on a Guest OS instance 100) is provisioned in a faster manner or efficient manner. Therefore, an embodiment of the invention provides a method and apparatus for recording an application initialization I/O sequence persistently and applying the sequence upon a guest OS restart in order to speed up the Guest OS launch times.

Method #2: A method and apparatus to record software application access patterns as “learnings” (in order to speed up cache warm up times across application restarts) is provided in an embodiment of the invention.

The record-replay engine 600 records, into the persistent database (which is LUN 500 or in LUN 500), the recorded information 605 which includes the initialization I/O trace (of an application) and the runtime access patterns and heuristics (or an application) such as frequency of I/O access and whether certain regions of the drive (e.g., LUN 300) were accelerated in a previous OS session. The record-replay engine 600 plays forward the same recorded information 605 when the guest OS restarts thereby retaining the state of the cache 400—furthermore, the cache 400 is warmed up based on the previously recorded information in an optimal manner.

This second method, in accordance with an embodiment of the invention, provides an understanding of how an application is accessing a storage area during the lifetime of the application.

Typically, an application is accessing a small subset of the data of the application. For example, an application will access approximately 10% to 20% of its application data, depending on the application type. It is known that most applications operate on a subset of the applications data. In one embodiment of the invention, a method (and a record-replay engine 600) will identify (and record) for a given time period (e.g., in a given month or other given time frame) the initialization I/O sequence of a software application running on the guest operating system (or the initialization I/O sequence of an instance of the guest OS instance or of an instance of a software application running on the Guest OS)) and will store the recorded initialization I/O sequence of the software application or guest OS instance or application instance (and learned heuristics associated with the initialization I/O sequence of the software application of guest OS instance or application instance) into the LUN 500 as recorded information 605. In contrast, conventional caching software methods will store I/O information of a software application in a storage that is locally attached to a server that runs the guest operating system and guest OS instances.

At least one advantage provided by an embodiment of the invention is that by applying the recorded initialization I/O sequences (and learned heuristics associated with these initialization I/O sequences), collectively identified herein as recorded information 605, across re-starts of guest OS instances or applications or application instances, one or more software applications will gain the benefit of optimal performance without downtime and software application restart issues.

Method #3: A method and apparatus to record application access patterns as “learnings” (in order to instantiate additional guest OS instances quickly) is provided in an embodiment of the invention.

The above method and record-replay engine 600, in accordance with an embodiment of the invention, can be extended to scalable application architectures where spawning additional application instances on additional guest machines achieves scalability. Using the guest OS snapshot and clone technology provided by the server virtualization technology, the same “learnings database” 605a (which is represented by recorded information 605 and applied and stored by record-replay engine 600 as recorded information 605a or learnings database 605a into cache 400) is applied on a new instance of the guest OS machine. Therefore, if a guest OS instances are launched in a guest OS machine, an embodiment of a method and apparatus of the invention will apply the recorded software application initialization I/O sequences (and learned heuristics, as discussed above), all contained in recorded information 605a, to any guest OS instance. As a result, any new guest OS instance will be launched with these learned initialization I/O sequences and learned heuristics as included in the learnings database 605a.

Method #4: A method and apparatus to prepare thin provisioned cache for performance across guest OS restarts is provided in an embodiment of the invention.

Mostly or typically, the ephemeral cache (400) is thin provisioned across reboots—the first write to a cache block incurs an overhead which is undesirable. Thin provisioned cache is commonly known to those skilled in the art. To overcome this, the record-replay engine 600 replays (applies) the learnings database across guest OS restarts (which previously had the effect of incurring the overhead) and the replay-record engine 600 effectively removes this learning database from the core application I/O code path and any untouched cache blocks are initialized via a write (with random data) once the learnings database 605a is replayed by the engine 600.

Therefore, in conventional systems, a cache has to undergo a priming process, and by extension, a software application will be initially sluggish or slow until the cache is fully primed, depending on the size of the cache. To solve these problems of conventional systems, the record-replay engine 600 will access the learning database 605a and apply the learned initialization information (from the learning database 605a) to a guest OS instance or another software application, in an asynchronous manner and/or as a background process, before the I/O activity of the software application starts. Therefore, an advantage provided by the record-replay module 600 and the learning database 605a is to permit a faster application start time and a thin provisioned cache that is available for use when a guest OS restarts.

In an embodiment of the invention, a method and apparatus for initializing or priming a cache will reduce the restart time of a software application. As an example, for a 100-bit cache, approximately five minutes or more may be required to fully prime and initialize this cache, and a software application will be unable to start until this cache is primed and initialized.

By way of example and not by way of limitation, assumed that the learned initialization I/O sequence and learned heuristics of an application (stored in a learnings database 605a) identify the region (or regions) of a primary storage (e.g., a primary storage such as LUN 300) that is a “hot region” (i.e., the region(s) that is highly accessed by the software application). For example, a hot region may be 50 gigabytes of data while the cache space (in cache 400) is 100 gigabytes. In an embodiment of the invention, a method and apparatus (via engine 600) will prefetch this 50 gigabytes of data (or other amounts of data in a hot region for another type of software application). This prefetching has the dual effect of priming the data required by the application when the application restarts, without the need for the application to actually wait for this data. Therefore, the application will start to access and use the cache 400 and the application will realize that there are some data being updated and the rest of the data in the cache 400 which is not primed, and the application will access and use the cache 400 after the record-replay module 600 has replayed the learned initialization I/O sequence and learned heuristics of the application in the learning database 605a. Thus, an embodiment of a method and apparatus of the invention efficiently provides a primed cache in order to start the application in a sooner and faster manner and in order for the application to go back to an original level of application performance in a sooner and faster manner.

The following is one example of a method in accordance with an embodiment of the invention. By way of example and not by way of limitation, assume that the MySQL application is a software application that running on the Guest OS machine instance 100. Prior to a start of a software application (MySQL in this example), a record-replay module 600 in an embodiment of the invention will access a learning database 605a in the cache 400 and then prefetch and replay the learned initialization I/O sequence and learned heuristics from the learning database 605a. The learned initialization I/O sequence and learned heuristics were previously recorded into the LUN 500 and into the learning database 605a by the record-replay module 600. The learned initialization I/O sequence and learned heuristics are learned information from the software application (e.g., MySQL) and are recorded by the record-replay module 600 when the MySQL will access a particular sets of defined blocks and in a particular sequence when the software application starts, and the record-replay module 600 then records these learned information into the learning database 605a. As an example, if the software application is the MySQL program, when the MySQL program starts, the MySQL program will access some blocks (e.g., block primarily located in a storage device such as, for example, in LUN 300), and the MySQL program will read from some of these blocks when the MySQL program starts and will write to some of these blocks when the MySQL program starts. These blocks can be, for example, metadata, indices, and tables. The learned database 605a can have other learned information related to the initialization information of other software applications. Accordingly, the record-replay module 600 will have the intelligence related to the initialization of one or more particular software applications (such as guest OS applications or other software applications such as MsSQL) by accessing and prefetching the learned initialization information (which is stored in the learned database 605a).

As an example, when the MySQL application program starts, the MySQL program accesses, for example, 4 gigabytes of data stored in blocks that are spread across in, for example, a primary storage (e.g., LUN 300). The record-replay module 600 will record the following information when the MySQL program starts (or when any other type of software application starts): (1) the content in these 4 gigabytes of data; (2) the regions (locations of the blocks) in the primary storage (e.g., LUN 300) that are being accessed by the software application wherein the blocks contain these initialization data (e.g., 4 gigabytes of data); (3) the most frequently used regions (i.e., hot regions) in the primary storage (by the software application) when the software application starts; (4) the particular sequence in which the software application will access the above-mentioned blocks; (5) the mode of central processing unit (CPU) utilization; (6) initialization I/O sequence of the software application; (7) heuristics related to the software application when the software application starts; and/or (8) other data and/or metadata related to the software application when the software application starts. Therefore, these initialization data listed in items (1) through (8) provide a snapshot of how the software application is utilizing the server 100, as well as I/O information and other heuristics, data, metadata, sequences, and other information related to the software application when the software application starts.

By way of example, if the software application is the MySQL program which will access 4 gigabytes of data when the MySQL program starts, and these 4 gigabytes of data may include 1 gigabyte of data in a first block location of a first block in the LUN 300, 100 megabytes of data in a second block location of a second block in the LUN 300, 200 megabytes of data in a third block location of a third block in the LUN 300, and other data in other block locations of other blocks in the LUN 300. The 4 gigabytes of data may be distributed in other manners in the LUN 300.

As known to those skilled in the art, software applications can access the primary storage in a random manner (or random nature) or/and a sequential manner (or sequential nature). Typically, applications do not necessarily access all application data in a sequential manner. For example, there are multi-threaded applications which access application data in a random manner, and this random access can slow down the application start-up time.

In an embodiment of the invention, the record-replay engine 600 will follow and record the pattern of access of a software application, and engine 600 will record the pattern of access as recorded information 605 into the LUN 500 and will also record this pattern of access into the learning database 605a in cache 400. By way of example, the patterns of access for on-line access are different among many different types of software applications. These patterns of access can be different in, for example, the number and types of tables and databases that are accessed by the software application types, and these tables and databases can be different depending on the different types of software applications. Additionally, for the same type of software application, the patterns of access can be different in, for example, the number and types of tables and databases that are accessed by instances of the same software application type. The record-replay engine 600 will record (in the learning database 605a) these patterns of access for different types of software applications and also identify the regions (locations) of the primary storage (e.g., LUN 300) that are most frequently used by the different types of software applications when the software applications are performing a start-up.

In contrast, the record-replay engine 600 does not wait for an application to request for application data when the application starts. The record-replay engine 600 will access the learning database 605a and pre-fetch the learned initialization data (recorded information) that is recorded in the learning database 605a, wherein the learned initialization data includes learned initialization I/O sequences and learned heuristics for the application as also discussed above.

The record-replay engine 600 will access the learned database 605a and prefetch the learned initialization information from the learned database 605a before the software application (e.g., MySQL) starts. When the software application starts or is restarted, the record-replay engine 600, based on the learned initialization information in the learning database 605a, has intelligence on the important initialization information (or all initialization information) for the software application that is starting or is being restarted. The record-replay engine 600 pre-fetches the learned initialization information in an optimal manner and prior to the start or restart of the software application.

By way of example and not by way of limitation, assume that record-replay engine 600 records, into the learned database 605a, the initialization information of a software application. Assume further that this software application is a financial application, although this software application can be any other type of software application. Assume further that this software application is live (in operation) for a given time period (e.g., one month or two months). Assume also that the server (which is running the software application) is turned off due to, for example, system maintenance or an installation of a new software that will require a restart of the server. If the server is turned off and will need to be re-started or re-booted, the initialization information of the software information in the cache is also lost, and conventional methods will require the software application to access the primary storage (e.g., LUN 300) and obtain the initialization information from the LUN 300 when the software application is starting or re-starting.

Additionally, in conventional methods, an instance of the software application will also be required to access the primary storage (e.g., LUN 300) and obtain the initialization information of the software application from the LUN 300 when the instance of software application (software application instance) is starting. As similarly described above, this process of accessing and obtaining the initialization information from the LUN 300 is a time-consuming process or is lengthy. A cache 300 is virtual to a new software application instance, and there is no guarantee that the new software application instance will fail over to a server that is communicatively coupled to the cache 300, and so there is no guarantee that the new software application instance will have access (and use) to the initialization information (in the cache 300) of the software application.

In contrast, a record-reply engine 600 will access the learning database 605a and pre-fetch the leaned initialization information from the learning database 605a prior to a start of an instance of a software application (or prior to a start of a software application itself). By way of example and not by way of limitation, the software application instance can take over the storage and/or other processing of data that was previously stored or otherwise processed by the software application. The software application instance can be in the same server 100 as the software application or can be in a different server from the software application. The record-replay engine 600 will apply the learned initialization information to the software application instance so that the software application instance can access and use the learned initialization information, and, as a result, the start time of the software application instance is reduced as compared to conventional systems. As a result, the software application instance can achieve an optimal level of performance sooner or achieve a previous level of performance, as compared to conventional systems which typically require new application instances to run about one month or about two months in order for the new application instances to reach the previous levels of performance.

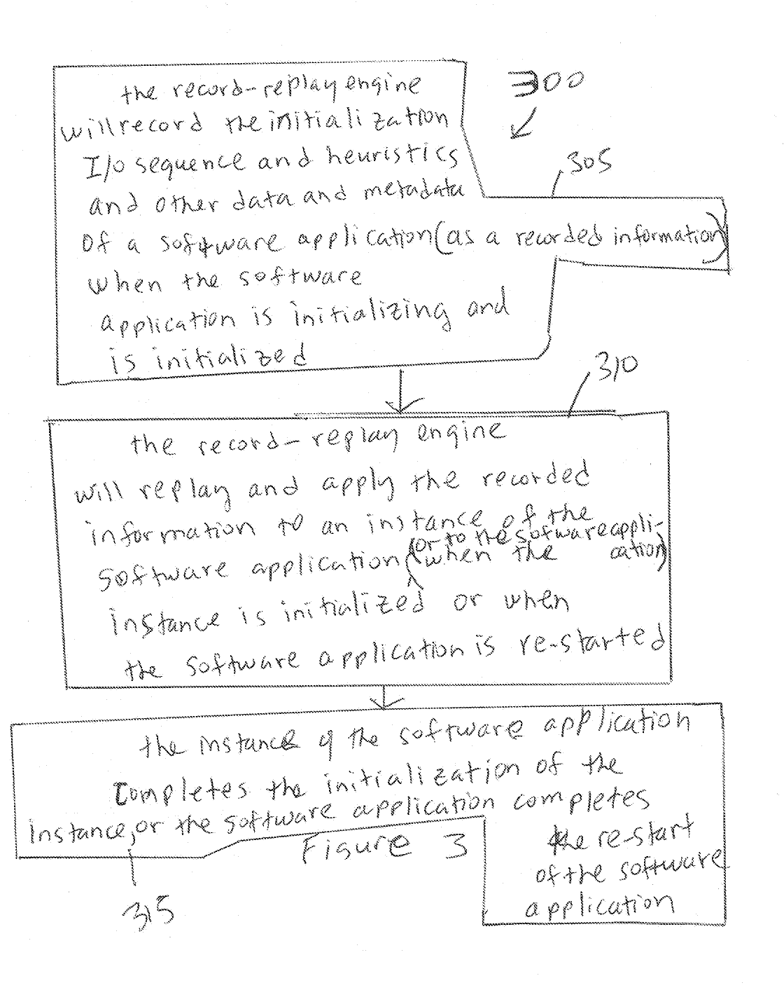

FIG. 3 is a flow diagram of a method 300 in accordance with an embodiment of the invention. The method 300 is a high-level or general flow of one methodology of an embodiment of the invention. At 305, the record-replay engine 600 will record the initialization I/O sequence and heuristics and other data and metadata of a software application (as a recorded information) when the software application is initializing and is initialized.

At 310, the record-replay engine will replay and apply the recorded information to an instance of the software application (or to the software application) when the instance is initialized or when the software application is re-started.

At 315 the instance of the software application completes the initialization of the instance, or the software application completes the re-start of the software application.

In an embodiment of the invention, an apparatus comprises: a physical server; a guest operating system (OS) instance that runs on the physical server; a cache communicatively coupled to the guest OS instance via the physical server and allocated the guest OS; a plurality of storage units; wherein the guest OS instance is configured to access data in the plurality of storage units via a network; and wherein the cache is configured to boost a performance of a guest OS machine of the guest OS instance.

In another embodiment of the invention, a method comprises: accessing, by a guest operating system (OS) instance, data in a plurality of storage units via a network; and boosting, by a cache, a performance of a guest OS of the guest OS instance.

In yet another embodiment of the invention, an article of manufacture, comprises a non-transient computer-readable medium having stored thereon instructions operable to permit an apparatus to: access, by a guest operating system (OS) instance, data in a plurality of storage units via a network; and boost, by a cache, a performance of a guest OS of the guest OS instance.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless.

It is also within the scope of the present invention to implement a program or code that can be stored in a machine-readable or computer-readable medium to permit a computer to perform any of the inventive techniques described above, or a program or code that can be stored in an article of manufacture that includes a computer readable medium on which computer-readable instructions for carrying out embodiments of the inventive techniques are stored. Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
a physical server;
a guest operating system (OS) instance that runs on the physical server;
a cache communicatively coupled to the guest OS instance via the physical server and allocated the guest OS;
a plurality of storage units;
wherein the guest OS instance is configured to access data in the plurality of storage units via a network; and
wherein the cache is configured to boost a performance of a guest OS machine of the guest OS instance.

2. The apparatus of claim 1, wherein the network comprises an Ethernet.

3. The apparatus of claim 1, wherein the cache comprises a solid state device (SSD) that provides a thin provisioned block storage.

4. The apparatus of claim 1, further comprising:
a record-replay engine configured to record and replay an initialization I/O (input/output) sequence of the guest OS machine for the guest OS instance in order to speed up a launch time of the guest OS machine upon a restart of the guest OS machine.

5. The apparatus of claim 4, wherein the record-replay engine is configured to record information associated with an initialization I/O sequence of the guest OS instance into a second storage unit and to replay the information into the cache when the guest OS machine restarts.

6. The apparatus of claim 5, wherein the information recorded in the second storage unit comprises at least one of: data indicating which regions of the storage unit that was accessed by the Guest OS instance during the initialization I/O sequence of the Guest OS instance, the size of the data in the storage unit that was accessed by the Guest OS instance during the initialization I/O sequence of the Guest OS instance, and/or the I/O sequence during the initialization of the Guest OS instance.

7. The apparatus of claim 4, wherein the record-replay engine is configured to record and replay software access patterns and heuristics in order to speed up a priming time of the cache across application restarts.

8. The apparatus of claim 4, wherein the record-replay engine is configured to record and replay prefetched learned initialization information in a learning database across guest OS restarts in order to permit a faster application start time and to permit the cache to be a thin provisioned cache that is available for use when a guest OS restarts.

9. The apparatus of claim 4, wherein the record-replay engine is configured to record and replay software access patterns and heuristics in order to instantiate additional guest OS instances quickly.

10. A method, comprising:
accessing, by a guest operating system (OS) instance, data in a plurality of storage units via a network; and
boosting, by a cache, a performance of a guest OS of the guest OS instance.

11. The method of claim 10, wherein the network comprises an Ethernet.

12. The method of claim 10, wherein the cache comprises a solid state device (SSD) that provides a thin provisioned block storage.

13. The method of claim 10, further comprising:
recording and replaying an initialization I/O (input/output) sequence of the guest OS machine for the guest OS instance in order to speed up a launch time of the guest OS machine upon a restart of the guest OS machine.

14. The method of claim 13, further comprising:
recording information associated with an initialization I/O sequence of the guest OS instance into a second storage unit and replaying the information into the cache when the guest OS machine restarts.

15. The method of claim 14, wherein the information recorded in the second storage unit comprises at least one of: data indicating which regions of the storage unit that was accessed by the Guest OS instance during the initialization I/O sequence of the Guest OS instance, the size of the data in the storage unit that was accessed by the Guest OS instance during the initialization I/O sequence of the Guest OS instance, and/or the I/O sequence during the initialization of the Guest OS instance.

16. The method of claim 13, further comprising:
recording and replaying software access patterns and heuristics in order to speed up a priming time of the cache across application restarts.

17. The method of claim 13, further comprising:
recording and replaying software access patterns and heuristics in order to instantiate additional guest OS instances quickly.

18. The method of claim 13, further comprising:
recording and replaying prefetched learned initialization information in a learning database across guest OS restarts in order to permit a faster application start time and to permit the cache to be a thin provisioned cache that is available for use when a guest OS restarts.

19. An article of manufacture, comprising:
a non-transient computer-readable medium having stored thereon instructions operable to permit an apparatus to:
access, by a guest operating system (OS) instance, data in a plurality of storage units via a network; and
boost, by a cache, a performance of a guest OS of the guest OS instance.

20. The article of manufacture of claim 19 further comprising instructions operable to permit the apparatus to:
record and replay an initialization I/O (input/output) sequence of the guest OS machine for the guest OS instance in order to speed up a launch time of the guest OS machine upon a restart of the guest OS machine.
